(19) United States
(12) Patent Application Publication
(10) Pub. No.: US 2007/0286040 A1
(43) Pub. Date: Dec. 13, 2007

(54) Safety ensuring device and disc apparatus utilizing the same

(75) Inventors: Shi-Kun Guo, Shenzhen (CN); Xue-Dong Tang, Shenzhen (CN); Chin-Sung Yang, Shenzhen (CN); Guan-Dong Zhao, Shenzhen (CN)

Correspondence Address: NORTH AMERICA INTELLECTUAL PROPERTY CORPORATION, P.O. BOX 506, MERRIFIELD, VA, 22116, US

(73) Assignee: HON HAI PRECISION INDUSTRY CO., LTD., Taipei Hsien (TW)

(21) Appl. No.: 11/309,891

(22) Filed: Oct. 18, 2006

(30) Foreign Application Priority Data
Jun. 9, 2006 (CN) 200610061068.6

(51) Int. Cl. G11B 7/00

(52) U.S. Cl. 369/44.34

(57) ABSTRACT

A safety ensuring device for a disc apparatus, which includes a lid and a spindle motor for rotating a disc, includes a first switch operable by the lid, a first controller electrically coupled to the first switch, a second switch simultaneously operable by the lid when activating the first switch, and a second controller electrically coupled to the second switch. The first controller is configured for receiving signals from the first switch and controls rotation of the spindle motor based on the received signals from the first switch. The second controller is configured for receiving signals from the second switch and controls the rotation of the spindle motor based on the received signals from the second switch. A disc apparatus utilizing the safety ensuring device is also disclosed.

### FIELD OF THE INVENTION

The present invention generally relates to disc apparatus and, more particularly, to a safety ensuring device for a disc apparatus.

### DESCRIPTION OF RELATED ART

Heretofore, there are known optical disc apparatus for reproducing information recorded on optical discs such as compact discs (CDs), digital versatile discs (DVDs), or the like, and optical disc apparatus for recording information on the optical discs. These optical disc apparatus operate by projecting a light beam from an optical pickup unit to an information-recorded surface of a loaded optical disc and detecting the light beam reflected from the information-recorded surface thereby to record information on and/or reproduce information from the information-recorded surface.

One known optical disc apparatus includes a receiving unit for receiving an optical disc therein and a lid for covering the optical disc received in the receiving unit. The optical disc apparatus also includes a spindle motor exposed in the receiving unit for rotatably supporting the optical disc. The optical disc is covered with the lid for preventing a user from touching the optical disc which is being rotated by the spindle motor. The lid can also prevent the optical disc from flying off by centrifugal force and thus harming people. Accordingly, the lid makes the optical disc apparatus safe for use and allows the optical disc to rotate without external interferences.

However, potential danger exists when the lid is unexpectedly released by accident.

Accordingly, a need exists in the industry for a safety ensuring device and a disc apparatus utilizing the same.

### SUMMARY OF THE INVENTION

A safety ensuring device for a disc apparatus, which includes a lid and a spindle motor for rotating a disc, includes a first switch operable by the lid, a first controller electrically coupled to the first switch, a second switch simultaneously operable by the lid when activating the first switch, and a second controller electrically coupled to the second switch. The first controller is configured for receiving signals from the first switch and controls rotation of the spindle motor based on the received signals from the first switch. The second controller is configured for receiving signals from the second switch and controls the rotation of the spindle motor based on the received signals from the second switch.

A disc apparatus includes a base, a lid pivotably attached to the base, a spindle motor configured for driving the disc to rotate at a predetermined speed, and a circuit board enclosed in the base and electrically coupled to the spindle motor. The lid is rotatable around a rotating axis, and forms a protrusion next to the rotating axis. The circuit board includes a first switch, a second switch, a first controller, and a second controller. The first switch and the second switch is simultaneously operable by the protrusion of the lid, and respectively connect to the first controller and the second controller. The first controller and the second controller mutually independently controls rotation of the spindle motor based on signals transmitted from the first controller and the second controller.

A disc apparatus includes a base defining an opening therein, a lid pivotably attached to the base, a spindle motor received in the base and configured for driving rotation of a disc, and first and second switches positioned in the base. The lid forms a protrusion positioned corresponding to the opening. The lid is pivotable between a covered position for covering the base, and an opened position for uncovering the base. The first and second switches are accessible from the opening. When the lid is positioned at the covered position, the protrusion extends into the opening and simultaneously presses the first and second switches so as to turn on the spindle motor. When the lid is rotated from the covered position toward the opened position, the first switch and the second switch are simultaneously released so as to turn off the spindle motor. The first switch includes a first pressing portion, and the second switch includes a second pressing portion. The first pressing portion and the second pressing portion are positioned at distinct positions along a front-to-back direction of the base. The protrusion forms a first activating surface and a second activating surface in a manner so as to be able to simultaneously press and release the first pressing portion and the second pressing portion, respectively.

Other systems, methods, features, and advantages of the present safety ensuring device and the present disc apparatus will be or become apparent to one with skill in the art upon examination of the following drawings and detailed description. It is intended that all such additional systems, methods, features, and advantages be included within this description, be within the scope of the present apparatus, and be protected by the accompanying claims.

### BRIEF DESCRIPTION OF THE DRAWINGS

Many aspects of the present safety ensuring device and the present disc apparatus can be better understood with reference to the following drawings. The components in the drawings are not necessarily to scale, emphasis instead being placed upon clearly illustrating the principles of the present device. Moreover, in the drawings, like reference numerals designate corresponding parts throughout the several views.

FIG. 1 is an isometric view of a disc apparatus in accordance with an exemplary embodiment;

FIG. 2 is an exploded, isometric view of the disc apparatus in FIG. 1, the disc apparatus including a lid, and a base;

FIG. 3 is an enlarged, partial view of the lid, viewed from an inverted aspect;

FIG. 4 is a block diagram of a safety ensuring device in accordance with an exemplary embodiment;

FIG. 5 is a partial, cross-sectional view of the disc apparatus in a closed state; and

FIG. 6 is a partial, cross-sectional view of the disc apparatus in an opened state.

### DETAILED DESCRIPTION OF THE INVENTION

Reference will now be made to the drawings to describe in detail, the preferred embodiments of the present safety ensuring device and the present disc apparatus.

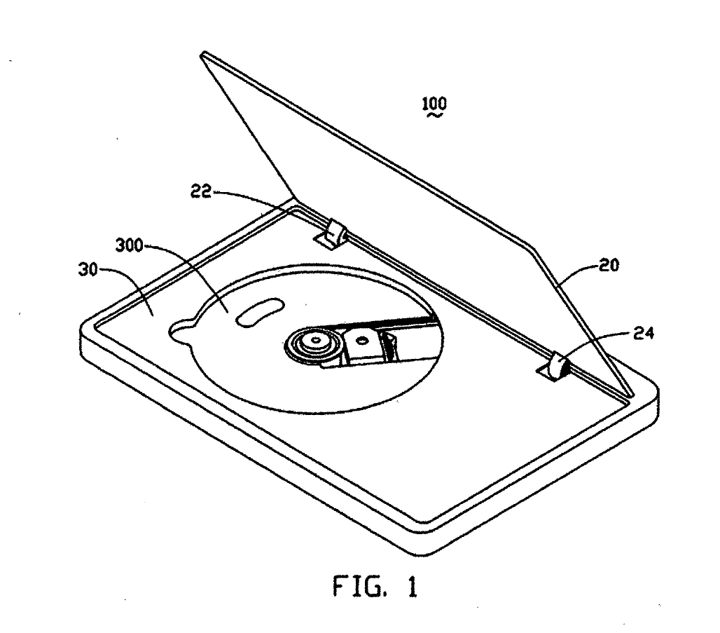

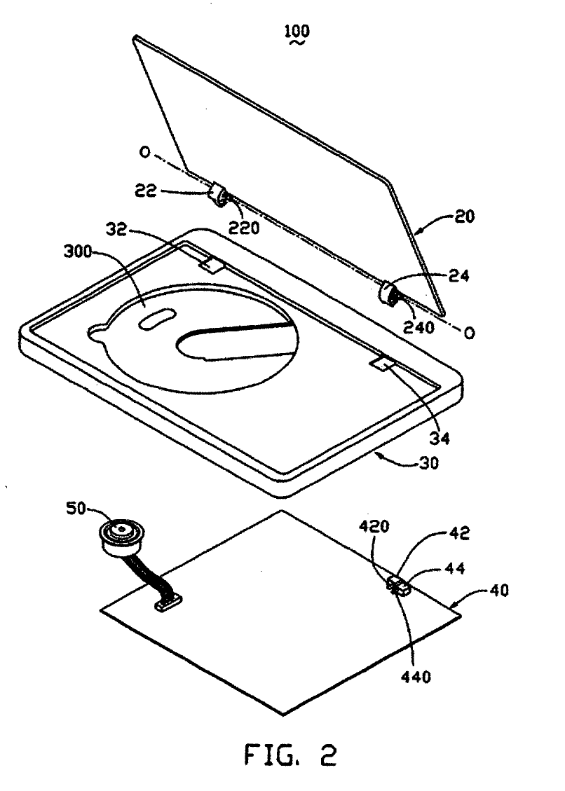

Referring to FIG. 1 and FIG. 2, a disc apparatus 100 in accordance with an exemplary embodiment is illustrated. The disc apparatus 100 includes a lid 20, a base 30, a circuit board 40, and a spindle motor 50. The lid 20 is pivotably attached to the base 30. The lid 20 can rotate with respect to the base 30 around a rotating axis OO. The base 30 is used for securing and receiving internal components of disc apparatus 100, including the circuit board 40 and the spindle motor 50. The circuit board 40 is a power supplier and controller of the spindle motor 50. The spindle motor 50 is electrically coupled to the circuit board 40, and is an actuator for rotating a disc positioned on the base 30.

The lid 20 includes a first protrusion 22 and a second protrusion 24 formed next to the rotating axis OO. The first protrusion 22 and the second protrusion 24 are substantially quadrant shapes, with axes thereof superposing each other. The first protrusion 22 extends a first shaft 220 along the rotating axis OO, and the second protrusion 240 extends a second shaft 240 along the rotating axis OO. The first shaft 220 and the second shaft 240 are engaged with the base 30 to connect the lid 20 to the base 30.

The base 30 is a frame for receiving and securing most components of the disc apparatus 100. The base 30 defines a recess 300 for receiving a disc therein. The spindle motor 50 protrudes from a center of the recess 300 to support the disc thereon and rotate the disc. The base 30 further defines a first opening 32 and a second opening 34 next to the rotating axis OO. The first opening 32 and the second opening 34 are corresponds to the first protrusion 22 and the second protrusion 24 respectively, allowing the first protrusion 22 and the second protrusion 24 to extend therethrough.

The circuit board 40 is a main circuit board of the disc apparatus 100. A first switch 42 and a second switch 44 are soldered on the circuit board 40. The first switch 42 and the second switch 44 are misalignedly arranged on the circuit board 40. The first switch 42 forms a first switch lever 420 retractable therefrom, and the second switch 44 forms a second switch lever 440 retractable therefrom. The first switch 42 and the second switch 44 are activated by the second protrusion 24 by pressing or releasing the first switch lever 420 and the second switch lever 440 to switch between a first state and a second state. Each of the first switch 42 and the second switch 44 has two states, the first state and the second state. The first switch 42 is in the first state when no external force is applied on the first switch lever 420, and in the second state when a constant external force is applied on the first switch lever 420. The states of the second switch 44 works in the same manner as the first switch 42. Both the first switch 42 and the second switch 44 are used to control the spindle motor 50.

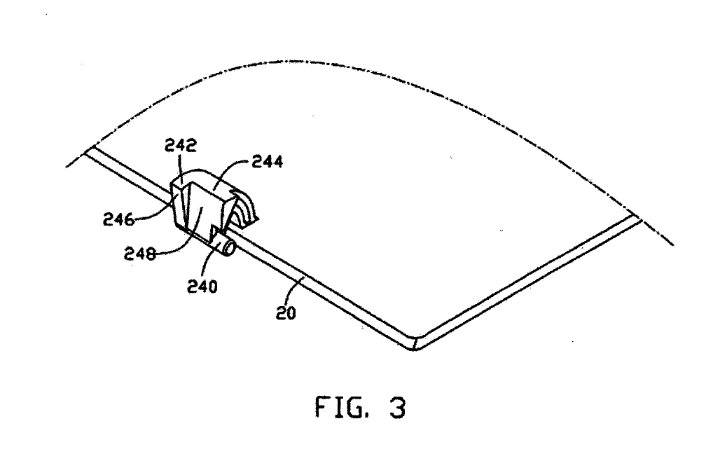

Referring to FIG. 3, a detailed structure of the second protrusion 24 is illustrated. The second protrusion 24 further includes a first portion 242 and a second portion 244 adjacent to each other around the rotating axis OO. The first portion 242 and the second portion 244 respectively include a first activating surface 246 and a second activating surface 248. The first activating surface 246 is a flat surface of the first portion 242 at a first angle to the lid 20, corresponding to the first switch 42. The second activating surface 248 is a flat surface of the second portion 244 at a second angle to the lid 20, corresponding to the second switch 44. The first angle of the first activating surface 246 and the second angle of the second activating surface 248 differ from each other. As the lid 20 rotates around the rotating axis OO, the first activating surface 246 and the second activating surface 248 rotates around the rotating axis OO to simultaneously push or release the first switch lever 420 of the first switch 42 and the second switch lever 440 of the second switch 44 respectively.

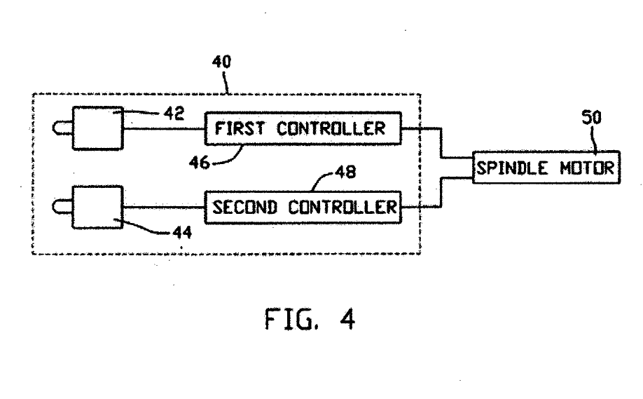

Referring to FIG. 4, a block diagram showing a detailed arrangement of the circuit board 40 and a relationship between the circuit board 40 and the spindle motor 50 is illustrated. The circuit board 40 includes a first controller 46 and a second controller 48 respectively connected to the first switch 42 and the second switch 44. The first controller 46 and the second controller 48 are both connected to the spindle motor 50. Each of the first controller 46 and the second controller 48 can be embodied in hardware, for example a controlling circuit, or software, for example a controlling program. When a first state signal indicating a current state (i.e. the first state or the second state) of the first switch 42 is transmitted to and received by the first controller 46, the first controller 46 controls the rotation of the spindle motor 50 in accordance with the first state signal. When a second state signal indicating a current state (i.e. the first state or the second state) of the second switch 44 is transmitted to and received by the second controller 48, the second controller 48 controls the rotation of the spindle motor 50 in accordance with the second state signal. That is, either of the first switch 42 and the second switch 44 can control the rotation of the spindle motor 50 via the corresponding controller, i.e. the first controller 46 or the second controller 48. Only when the first controller 46 receives the first state signal indicating the first switch 42 in the second state and the second controller 48 receives the second state signal indicating the second switch 44 is in the second state, that the spindle motor 50 is allowed to rotate at any required speed so as to reproduce information from and/or record information onto the disc positioned in the recess 300. Otherwise, the spindle motor tops rotating to avoid possible potential danger corresponding to a rotating disc.

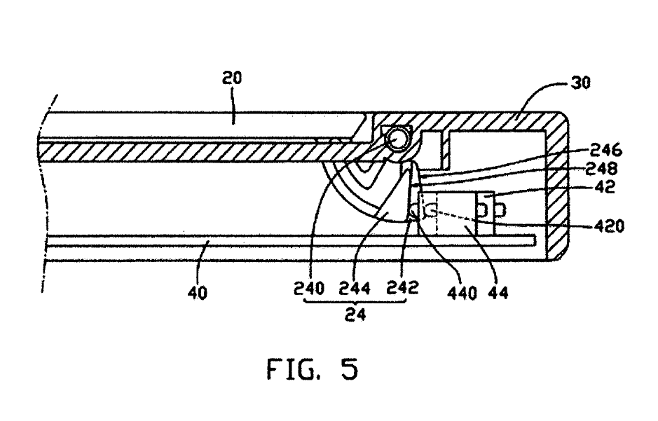

Referring to FIG. 5, a partial, cross-sectional view of the disc apparatus 10 in a closed state is illustrated. In the closed state, the lid 20 fully covers the base 30. The first and second switches 242, 244 are activated by the second protrusion 24. That is, the first switch lever 420 of the first switch 242 is pressed by the first activating surface 246, and the second switch lever 440 is pressed by the second activating surface 248. The first and second controllers 46, 48 receive the first and second state signals transmitted from the first and the second switches 42, 44, and allow the spindle motor 50 to rotate at any desired speed, performing regular recording or reproducing.

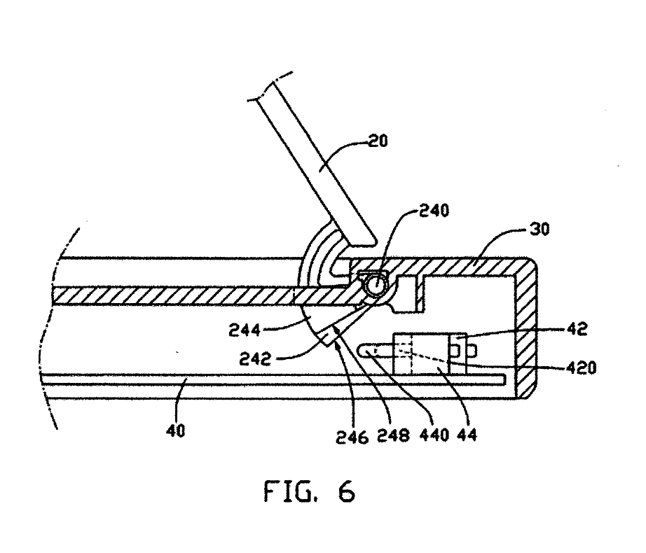

Referring to FIG. 6, when the lid 20 is opened on purpose or by accident, the second protrusion 24 gradually leaves the first and second switches 42, 44. As the second protrusion 24 rotates, the first activating surface 246 and the second activating surface 248 simultaneously release the first switch lever 420 of the first switch 42 and the second switch lever 440 of the second switch 44. In such state, the first and second controllers 46, 48 receive the first and second state signals transmitted from the first and second switches 42, 44, and prohibit the spindle motor 50 from rotation.

Referring to FIG. 5 and FIG. 6, the first switch 42 and the second switch 44 are directly activated or released by the first activating surface 246 and the second activating surface 248. Each of the first switch 42 and the second switch 44 is connected to a separate controller 46/48 to control the rotation of the spindle motor 50. Once one of the first switch 42 and the second switch 44 or one of the first controller 46 and the second controller 48 is broken or not operational, the other one is still operational. This further protects users against danger or potential danger, and ensures users' safety.

For a given disc apparatus 10, a first central angle of the first portion 242 (an angle of the first activating surface 246 with respect to the lid 20) and a second central angle of the second portion 244 (an angle of the second activating surface 248 with respect to the lid 20) can be varied in accordance with safety requirements. Preferably, the first central angle and the second central angle are approximately 90 degrees.

The foregoing description of the exemplary embodiments of the invention has been presented only for the purposes of illustration and description and is not intended to be exhaustive or to limit the invention to the precise forms disclosed. Many modifications and variations are possible in light of the above teaching. The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A safety ensuring device for a disc apparatus, the disc apparatus including a lid and a spindle motor for rotating a disc, the safety ensuring device comprising:
a first switch operable by the lid;
a first controller electrically coupled to the first switch, the first controller being configured for receiving signals from the first switch and controlling rotation of the spindle motor based on the received signals from the first switch;
a second switch simultaneously operable by the lid when activating the first switch; and
a second controller electrically coupled to the second switch, the second controller being configured for receiving signals from the second switch and controlling the rotation of the spindle motor based on the received signals from the second switch.

2. The safety ensuring device as claimed in claim 1, wherein each of the first switch and the second switch defines a first state and a second state, and the first switch and the second switch are in the first state when the lid is closed.

3. The safety ensuring device as claimed in claim 1, wherein the rotation of the spindle motor is prohibited by the corresponding controller when either of the first switch and the second switch is switched from the first state to the second state by the lid.

4. A disc apparatus, comprising:
a base;
a lid pivotably attached to the base, the lid being rotatable around a rotating axis, the lid forming a protrusion next to the rotating axis;
a spindle motor configured for driving a disc to rotate at a predetermined speed; and
a circuit board enclosed in the base and electrically coupled to the spindle motor, the circuit board including a first switch, a second switch, a first controller, and a second controller, the first switch and the second switch being simultaneously operable by the protrusion of the lid and respectively connecting to the first controller and the second controller, the first controller and the second controller mutually independently controlling rotation of the spindle motor based on signals transmitted from the first controller and the second controller.

5. The disc apparatus as claimed in claim 4, wherein the protrusion comprises a first portion and a second portion adjacent to each other along the rotating axis, and the first portion and the second portion are respectively used to activate the first switch and the second switch.

6. The disc apparatus as claimed in claim 5, wherein the first switch forms a first switch lever elongating therefrom, the second switch forms a second switch lever elongating therefrom, and the first switch lever and the second switch lever are respectively pressed or released by the first portion and the second portion of the lid.

7. The disc apparatus as claimed in claim 5, wherein the first portion defines a first activating surface for activating the first switch, the second portion defines a second activating surface for activating the second switch, and the first activating surface and the second activating surface are staggered.

8. The disc apparatus as claimed in claim 4, wherein the protrusion is in a quadrant shape with an axis thereof superposing the rotating axis of the lid.

9. The disc apparatus as claimed in claim 8, wherein the protrusion comprises a first activating surface and a second activating surface extending through the rotating axis, and the first activating surface and the second activating surface are respectively used to press or release the first switch and the second switch.

10. The disc apparatus as claimed in claim 9, wherein the first activating surface and the second activating surface are staggered.

11. The disc apparatus as claimed in claim 4, wherein the first switch and the second switch are staggered on the circuit board.

12. The disc apparatus as claimed in claim 11, wherein the first switch and the second switch are plunger switches, each of the first switch and the second switch forms a switch lever retractable therefrom.

13. The disc apparatus as claimed in claim 11, wherein the protrusion defines a first activating surface and a second activating surface staggered, and the first activating surface and the second activating surface are respectively used to press the switch levers of the first switch and the second switch.

14. The disc apparatus as claimed in claim 4, wherein a shaft extend along the rotating axis of the lid from the protrusion, and the shaft is engaged with the base.

15. A disc apparatus comprising:
a base defining an opening therein;
a lid pivotably attached to the base, the lid forming a protrusion positioned corresponding to the opening, the lid being pivotable between a covered position for covering the base, and an opened position for uncovering the base;
a spindle motor receiving in the base and configured for driving rotation of a disc; and
first and second switches positioned in the base and accessible from the opening, wherein when the lid is positioned at the covered position, the protrusion extends into the opening and simultaneously presses the first and second switches so as to turn on the spindle motor, when the lid is rotated from the covered position toward the opened position, the first switch and the second switch are simultaneously released so as to turn off the spindle motor;
wherein the first switch includes a first pressing portion, the second switch includes a second pressing portion, the first pressing portion and the second pressing portion are positioned at distinct positions along a front-to-back direction of the base, and the protrusion forms a first activating surface and a second activating surface in a manner so as to be able to simultaneously press and release the first pressing portion and the second pressing portion, respectively.
